(19) United States
(12) Patent Application Publication
(10) Pub. No.: US 2013/0242546 A1
(43) Pub. Date: Sep. 19, 2013

(54) METHOD AND SYSTEM FOR LIGHTING

(71) Applicant: MULTI/FORMS, INC., Farmers Branch, TX (US)

(72) Inventor: Jose Nicolas Sainz, Lewisville, TX (US)

(73) Assignee: MULTI/FORMS, INC., Farmers Branch, TX (US)

(21) Appl. No.: 13/801,926

(22) Filed: Mar. 13, 2013

Related U.S. Application Data
(60) Provisional application No. 61/612,675, filed on Mar. 19, 2012.

(51) Int. Cl. F21L 4/02

(52) U.S. Cl. CPC F21L 4/02
USPC 362/183

(57) ABSTRACT

The present invention relates to a lighting system. The lighting system includes a panel member that is radially fixed to a radial element of a rotatable wheel. A first end of the panel member is arranged closer to an axle of the rotatable wheel than a second end of the panel member. A plurality of light-emitting diodes are attached to the panel member in a substantially linear arrangement. The plurality of light-emitting diodes span substantially from the first end to the second end. A power-supply module powers the plurality of light-emitting diodes. The power-supply module is arranged adjacent the first end. A charging port is coupled to the power-supply module.

### CROSS-REFERENCE TO RELATED APPLICATIONS

This application claims priority from, and incorporates by reference, for any purpose, the entire disclosure of, U.S. Provisional Patent Application No. 61/612,675, filed Mar. 19, 2012.

### BACKGROUND

1. Field of the Invention

The present invention relates generally to lighting systems and more particularly, but not by way of limitation to lighting systems utilizing an array of light-emitting diodes for use with wheeled transports.

2. History of the Related Art

Outdoor activities during periods of low visibility frequently require an adequate source of lighting. Bicycling, in particular, requires appropriate lighting during conditions such as rain, fog, early-morning light, and night-time darkness to illuminate various road hazards and to make a cyclist visible to nearby automobiles and pedestrians. Lighting systems for bicycles and other small wheeled vehicles have been developed and utilized for many years. In particular, lighting systems for bicycles typically include a headlamp mounted on a front region of a bicycle such as, for example, the handlebars and a tail lamp, which is usually coupled under a seat of the bicycle. Such prior lighting systems typically illuminate only a region directly in front of, and directly behind, the bicycle with little side illumination. In such cases, the bicycle is often nearly invisible when viewed from the side such as, for example, by an approaching automobile. Further, such prior lighting systems often require a power source such as, for example, a battery. Such power sources are often bulky and may make the bicycle difficult to operate. In addition, power requirements associated with prior lighting systems often necessitate frequent re-charging of the power source, thus making rides of extended duration infeasible. Finally, such prior lighting systems often generate significant amounts of aerodynamic drag, which results in the bicycle being difficult to operate.

### SUMMARY

The present invention relates generally to lighting systems and more particularly, but not by way of limitation to lighting systems utilizing an array of light-emitting diodes for use with wheeled transports. In one aspect, the present invention relates to a lighting system. The lighting system includes a panel member that is radially fixed to a radial element of a rotatable wheel. A first end of the panel member is arranged closer to an axle of the rotatable wheel than a second end of the panel member. A plurality of light-emitting diodes are attached to the panel member in a substantially linear arrangement. The plurality of light-emitting diodes span substantially from the first end to the second end. A power-supply module powers the plurality of light-emitting diodes. The power-supply module is arranged adjacent the first end. A charging port is coupled to the power-supply module.

In another aspect, the present invention relates to a lighting method. The method includes fixing a panel member to a radial element of a rotatable wheel such that a first end of the panel member is arranged closer to an axle of the rotatable wheel than a second end of the panel member. A charging module is coupled to a charging port of a power supply module. The power supply module is arranged adjacent to the first end. The method further includes charging, via the charging module, a plurality of light-emitting diodes arranged on the panel member in a substantially linear arrangement and producing at least one of a strobe effect and a persistence effect when the rotatable wheel is rotated about the axle.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1A is a front view of a lighting system according to an exemplary embodiment;

FIG. 1B is a front view of the lighting system of FIG. 1 illustrating a charger according to an exemplary embodiment;

FIG. 2 is a circuit diagram illustrating the lighting system of FIG. 1 according to an exemplary embodiment;

FIG. 3 is schematic diagram of a lighting system according to an exemplary embodiment;

FIG. 4A is a central perspective view illustrating installation of the lighting system of FIG. 1 according to an exemplary embodiment;

FIG. 4B is a radial perspective view illustrating installation of the lighting system of FIG. 1 according to an exemplary embodiment; and

FIG. 4C is a perspective view illustrating installation of the lighting system of FIG. 3 according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

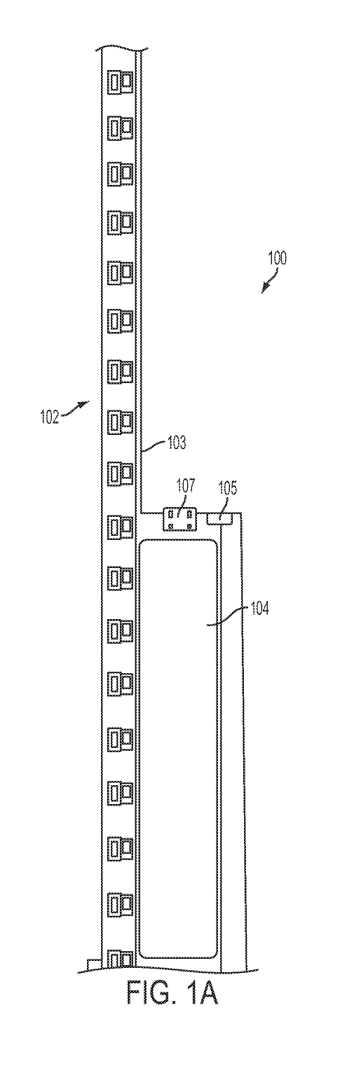

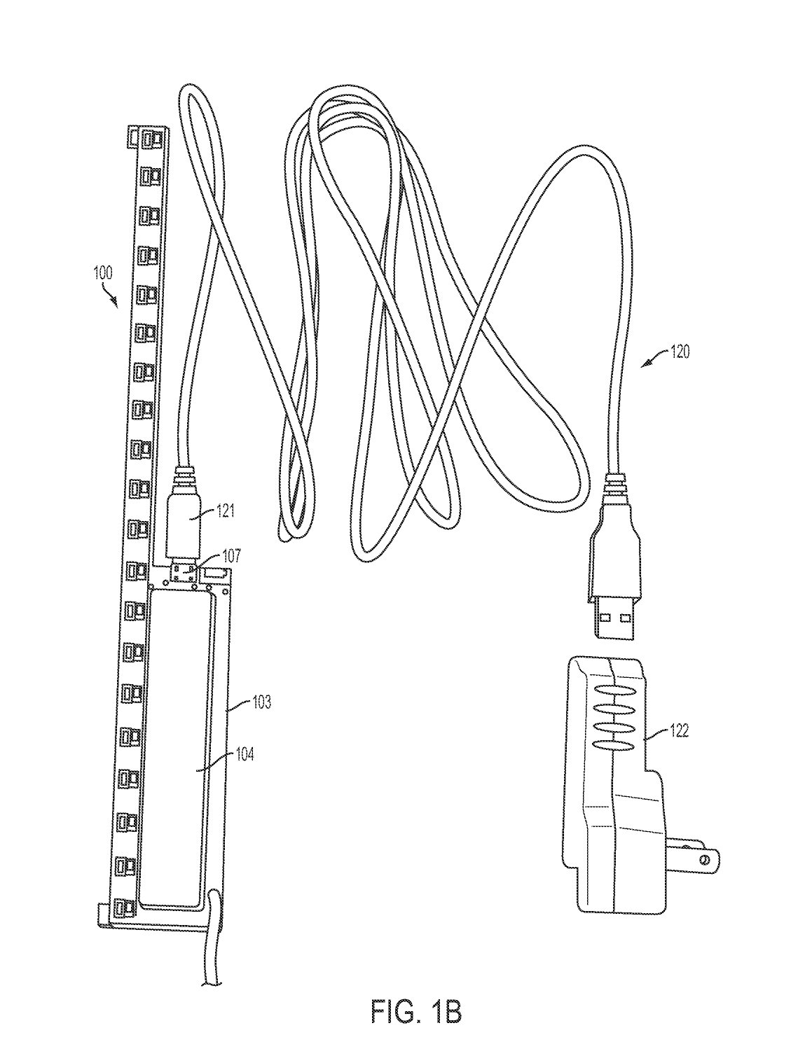

FIG. 1A is a front view of a lighting system 100. The lighting system 100 includes a light-emitting diode (“LED”) array 102 and a power-supply module 104 electrically coupled to the LED array 102. An LED is a semiconductor light source. When an LED is forward-biased (switched on), electrons are able to recombine with electron holes present in the LED thereby releasing energy in the form of light. This effect is known as “electroluminescence.” The color of light emitted by the LED is determined by an energy gap of the semiconductor material. LEDs possess many advantages over incandescent light sources including lower energy consumption, longer lifetime, smaller size, and faster switching.

The LED array 102 and the power-supply module 104 are disposed on a panel member 103; however, in other embodiments, the power-supply module 104 may be located elsewhere. The panel member 103 is, for example, a traced circuit board having electrical conductors embedded therein. In a typical embodiment, the panel member 103 is formed of a lightweight, durable material such as, for example, silicon, rigid plastic, or other appropriate material as dictated by design requirements.

A switch 105 is electrically coupled to at least one of the LED array 102 and the power-supply module 104. The switch is disposed on the panel member 103; however, in other embodiments, lighting systems utilizing principles of the invention may include a switch that is disposed elsewhere.

FIG. 1B is a front view of the lighting system 100 illustrating a charging system 120. The charging system 120 includes a cord 121 and a wall adapter 122. A charging port 107 is disposed on the panel member 103 and electrically coupled to the power-supply module 104. As shown in FIG. 1B, the charging port 107 includes a micro universal serial bus (“USB”) connection; however, in other embodiments, other connections could be utilized as dictated by design requirements. The cord 121 is received into the charging port 107. The cord 121 is a USB-type cable; however, in other embodiments, lighting systems utilizing principles of the invention may include any type of cord. The wall adapter 122 is shown positioned to be electrically coupled to the cord 121. In a typical embodiment, the wall adapter 122 configures the cord 121 to be received into an alternating-current wall outlet. In a typical embodiment, the charging system 120 is adapted to be connected to at least one of a wall outlet, a computer USB port, an automotive USB port, an automotive battery, or other source of electrical power thus allowing the lighting system 100 to receive an electrical charge from a variety of sources.

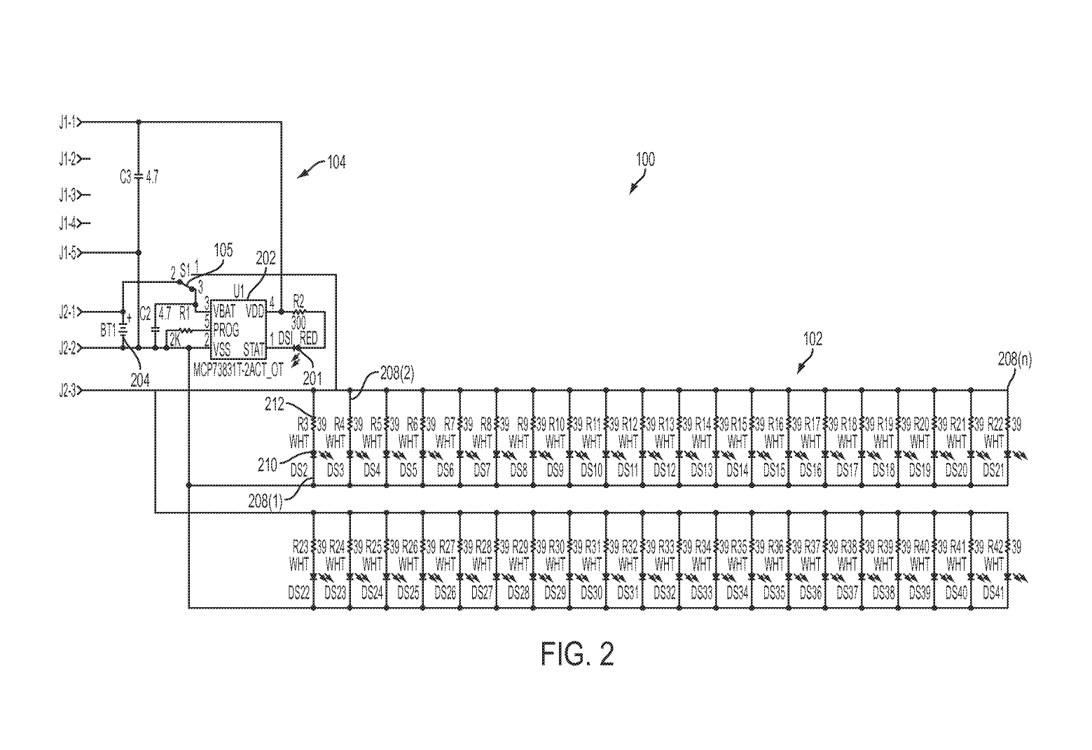

FIG. 2 is a circuit diagram illustrating the lighting system 100. The power-supply module 104 includes a charge-management controller 202 electrically coupled to a battery 204. In a typical embodiment, the battery 204 is a lithium-polymer battery; however, in other embodiments, lighting systems utilizing principles of the invention may include batteries such as, nickel-cadmium batteries, and the like. The charging port 107 (shown in FIG. 1B) is electrically coupled to the battery 204 and the charge-management controller 202. The battery is electrically coupled to the LED array 102 and the charge-management controller 202 via the switch 105. A LED 201 is electrically coupled to the charge-management controller 202. In a typical embodiment, the LED 201 is red in color; however, any color LED may be utilized. In a typical embodiment, the charge-management controller 202 is a linear, five-lead controller employing a constant-current and a constant-voltage algorithm. In a typical embodiment, when the charging port 107 is coupled to a source of electrical power, the charge-management controller 202 regulates a current and a voltage supplied to the battery 204 thereby preventing overcharging of the battery 204. During charging of the battery 204, the charge-management controller 202 supplies power to, and illuminates, the LED 201. When the battery 204 reaches a maximum charge, the charge-management controller 202 directs the LED 201 to turn off thereby indicating that charging is complete.

Still referring to FIG. 2, the LED array 102 includes LED units 208(1)-(n) that are electrically coupled in parallel to the power-supply module 104. In other embodiments, LED arrays utilizing principles of the invention may include LED units electrically coupled in series to the power-supply module 104. The LED units 208(1)-(n) include a LED 210 electrically coupled in series to a resistor 212. In a typical embodiment, the LED 210 is white in color; however, in other embodiments, the LED 210 may be any appropriate color. In other embodiments, LED arrays utilizing principles of the invention may include LEDs of multiple colors. In other embodiments, LED arrays utilizing principles of the invention may include LED units without the resistor 212.

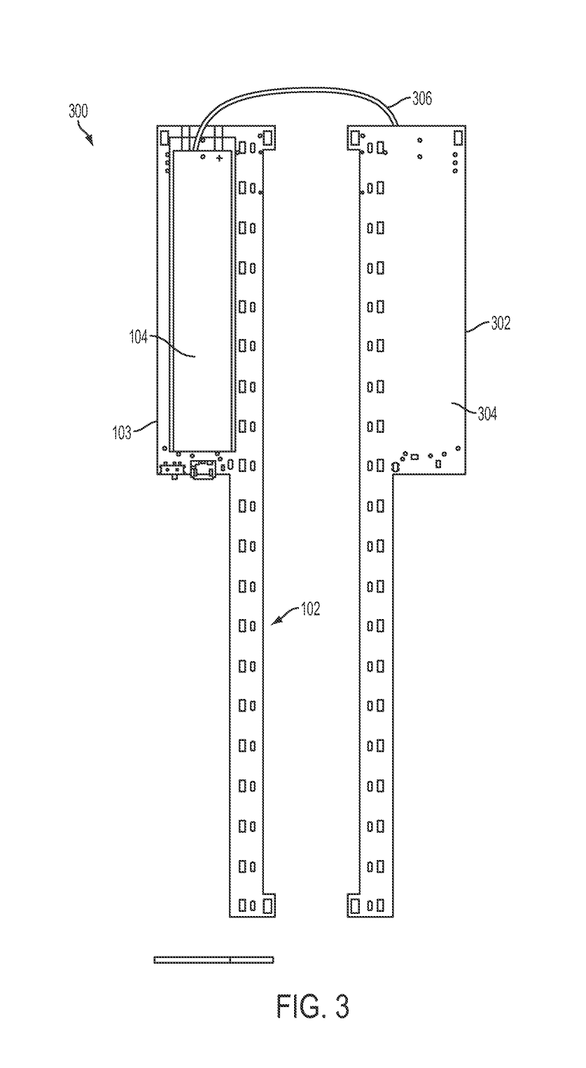

FIG. 3 is schematic diagram of a lighting system 300. The lighting system 300 includes a second LED array 302. In a typical embodiment, the second LED array 302 is similar in construction to the LED array 102 and is disposed on a second panel member 304. In a typical embodiment, the second panel member 304 is similar in construction to the panel member 103 and is, for example, a traced circuit board having electrical conductors embedded therein. The second LED array 302 is electrically coupled to the power-supply module 104 via a power-transmission member 306. The power-transmission member 306 is operable to transmit electrical power from the power supply module 104 to the second LED array 302. In a typical embodiment, the power-transmission member 306 is, for example, a flexible insulated electrical wire such as, for example, a ribbon cable. In other embodiments, lighting systems utilizing principles of the invention may include power-transmission members constructed from, for example, flexible Mylar or flat plastic. In still other embodiments, electrical power may be transmitted from the power-supply module 104 to the second LED array 302 via, for example, a wireless interface. In other embodiments, the second LED array 302 may be electrically coupled to a second power-supply module (not shown) thus allowing the second LED array 302 to be utilized independently of the LED array 102 and independently of the power-supply module 104. In other embodiments, lighting systems utilizing principles of the invention may include any number of LED arrays as dictated by design requirements.

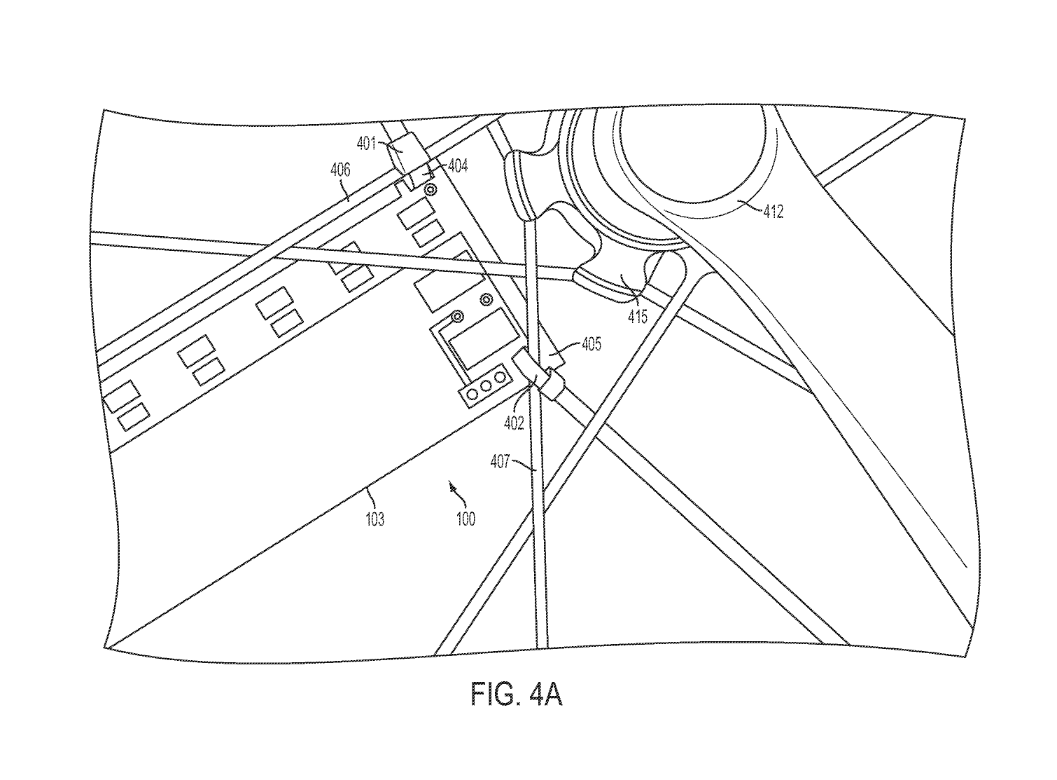

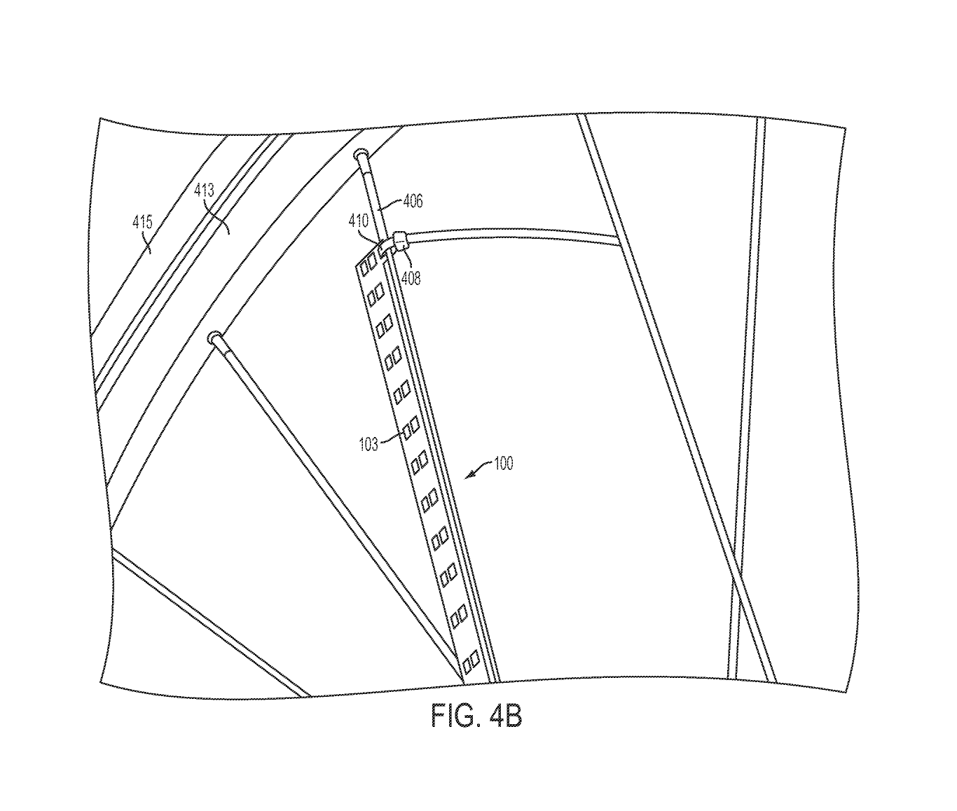

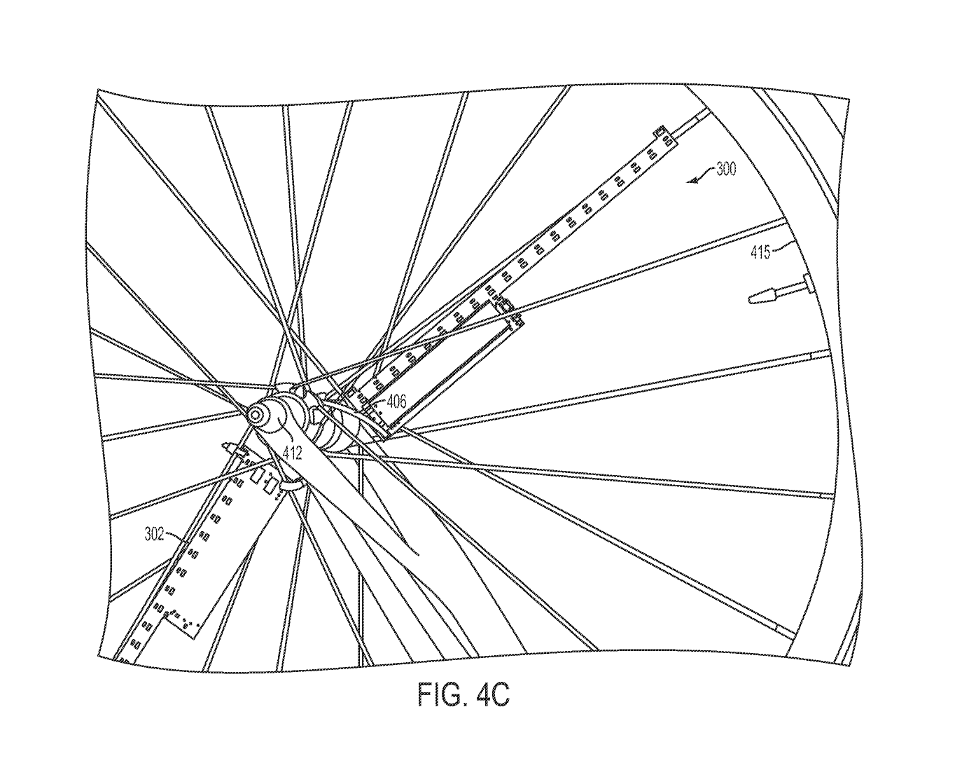

FIG. 4A is a central perspective view illustrating installation of the lighting system 100. By way of example, the lighting system 100 is illustrated in FIGS. 4A-4B as being secured to a bicycle wheel 415; however, one skilled in the art will recognize that the lighting system 100 could be secured to any type of wheel such as, for example, a stroller wheel, a wheelchair wheel, a recumbent bicycle wheel, or any other device including at least one wheel. A first attachment hole 404 and a second attachment hole 405 are formed in a region of the panel member 103 adjacent to a hub 412. A first fastener 401 is placed through the first attachment hole 404 and coupled to a first radial element 406. A second fastener 402 is placed through the second attachment hole 405 and coupled to a second radial element 407. In a typical embodiment, the first radial element 406 and the second radial element 407 are, for example, spokes. By way of example, the first fastener 401 and the second fastener 402 are illustrated in FIG. 4A as wire-tie-type fasteners; however, in other embodiments, the first fastener 401 and the second fastener 402 may be any appropriate type of fastener such, as for example, a clip, a hook, a karabiner, and the like. In other embodiments, lighting systems utilizing principles of the invention may be fastened to a wheel using, for example, adhesives or adhesive tape.

FIG. 4B is a radial perspective view illustrating installation of the lighting system 100. A third attachment hole 410 is formed in a region of the panel member 103 adjacent to a rim 413. A third fastener 408 is placed through the third attachment hole 410 and coupled to the first radial element 406. The third fastener 408 is similar in terms of construction and operation to the first fastener 401 and the second fastener 402 discussed above with respect to FIG. 4A.

FIG. 4C is a perspective view illustrating installation of the lighting system 300. By way of example, the lighting system 300 is illustrated in FIG. 4C as being secured to the bicycle wheel 415. The power-transmission member 306 is wrapped around the hub 412 so as to prevent the power-transmission member 306 from interfering with rotation of the bicycle wheel 415. The second LED array 302 is secured to the bicycle wheel 415 as described above with respect to the lighting system 100.

Referring now to FIGS. 4A-4C, after installation, a weight of the LED array 102 and a weight of the second LED array 302 are distributed along substantially an entire radius of the bicycle wheel 415. Such an arrangement reduces interference with rotation of the wheel caused by the weight of the LED array 102 and the weight of the second LED array 302. In addition, the panel member 103 and the second panel member 304 have a very small thickness. Such a shape of the panel member 103 and the second panel member 304 substantially reduces aerodynamic drag on, for example, the bicycle wheel 415. Further, the shape of the panel member 103 and the second panel member 304 reduces the influence of cross winds on the bicycle wheel 415.

Advantages of the lighting system 100 and the lighting system 300 will be apparent to those skilled in the art. First, the lighting system 100 and the lighting system 300 each provide forward visibility in the range of approximately ten to approximately fifteen feet. When viewed from a side the lighting system 100 and the lighting system 300, due to persistence of vision, are perceived as a plurality of unbroken circles of light concentric with the bicycle wheel 415. The plurality of unbroken circles of light are highly visible to nearby automobiles. When viewed from a front or a rear, the lighting system 100 and the lighting system 300, due to rotation of the bicycle wheel 415, create a stroboscopic effect that is visible to nearby automobiles. Second, low power requirements associated with the lighting system 100 and the lighting system 300 typically result in an operation time between charges of approximately two hours or more.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. For example, although the lighting system 100 and the lighting system 300 have been described herein as used in conjunction with the bicycle wheel 415, one skilled in the art will recognize that the lighting system 100 and the lighting system 300 may be utilized in conjunction with a stroller, a wheelchair, a recumbent bicycle, or any other device including at least one wheel. It is intended that the Specification and examples be considered as illustrative only.

What is claimed is:

1. A lighting system comprising:
a panel member radially fixed to a radial element of a rotatable wheel, a first end of the panel member arranged closer to an axle of the rotatable wheel than a second end of the panel member;
a plurality of light-emitting diodes attached to the panel member in a substantially linear arrangement spanning substantially from the first end to the second end;
a power-supply module powering the plurality of light-emitting diodes, the power-supply module arranged adjacent the first end; and
a charging port coupled to the power-supply module.

2. The lighting system of claim 1, wherein the charging port is a micro-USB-type port.

3. The lighting system of claim 1, comprising a charging module interoperably coupled to the charging port and charging the lighting system.

4. The lighting system of claim 3, wherein the charging module receives a charge from at least one of a computer, an alternating-current adapter, and a portable USB charging unit.

5. The lighting system of claim 1, comprising a battery interoperably coupled to the charging port.

6. The lighting system of claim 1, wherein the plurality of light-emitting diodes produce a strobe effect when viewed from a direction perpendicular to the axle when the rotatable wheel is rotating about the axle.

7. The lighting system of claim 1, wherein the plurality of light-emitting diodes produce a persistence effect when viewed from a direction parallel to the axle when the rotatable wheel is rotating about the axle.

8. The lighting system of claim 1, comprising a second panel member interoperably coupled to the panel member, the second panel member being radially fixed to a second radial element of the rotatable wheel.

9. The lighting system of claim 8, comprising a second plurality of light-emitting diodes attached to the second panel member in a substantially linear arrangement.

10. The lighting system of claim 9, wherein the second plurality of light-emitting diodes is interoperably coupled to the power-supply module.

11. The lighting system of claim 1, wherein the radial element is a spoke.

12. A method of using a lighting system, the method comprising:
fixing a panel member to a radial element of a rotatable wheel such that a first end of the panel member arranged closer to an axle of the rotatable wheel than a second end of the panel member;
coupling a charging module to a charging port of a power supply module, the power supply module being arranged adjacent to the first end;
charging, via the charging module, a plurality of light-emitting diodes arranged on the panel member in a substantially linear arrangement; and
producing at least one of a strobe effect and a persistence effect when the rotatable wheel is rotated about the axle.

13. The method of claim 12, wherein charging comprises coupling the charging module to at least one of a computer, an alternating-current adapter, and a USB charging unit.

14. The method of claim 13, comprising coupling the charging module to a computer via at least one of a USB and a micro-USB connection.

15. The method of claim 12, comprising fixing a second panel member to a second radial element of the rotatable wheel.

16. The method of claim 15, comprising a second plurality of light-emitting diodes disposed on the second panel member to the power-supply module.

17. The method claim 12, comprising producing a strobe effect when viewed from a direction perpendicular to the axle when the rotatable wheel is rotating about the axle.

18. The method claim 12, comprising producing a persistence effect when viewed from a direction parallel to the axle when the rotatable wheel is rotating about the axle.
